(19) United States
(12) Patent Application Publication
(10) Pub. No.: US 2025/0381965 A1
(43) Pub. Date: Dec. 18, 2025

(54) METHOD AND DEVICE FOR CONTROLLING FUNCTION OF VEHICLE

(71) Applicants: HYUNDAI MOTOR COMPANY, Seoul (KR); KIA CORPORATION, Seoul (KR)

(72) Inventors: Minju Kim, Hwaseong-si (KR); Sae Yong Jang, Hwaseong-si (KR)

(73) Assignees: HYUNDAI MOTOR COMPANY, Seoul (KR); KIA CORPORATION, Seoul (KR)

(21) Appl. No.: 18/967,639

(22) Filed: Dec. 3, 2024

(30) Foreign Application Priority Data
Jun. 17, 2024 (KR) 10-2024-0078307

(51) Int. Cl. B60W 50/00; G06Q 10/0631; G06Q 10/083

(52) U.S. Cl. CPC B60W 50/0098; G06Q 10/06311; G06Q 10/083; B60W 2050/0083; B60W 2556/40; B60W 2556/50

(57) ABSTRACT

Provided is a method and a device for controlling a function of a vehicle that controls a delivery-specific function of a vehicle in accordance with a delivery situation. The method may include receiving vehicle driver's work schedule data, delivery map data, and delivery stage data from a server, allocating a work schedule variable, a delivery stage variable, and a delivery destination characteristic variable in a memory, performing a computation based on the work schedule data, the delivery map data, and the delivery stage data to set values in the work schedule variable, the delivery stage variable, and the delivery destination characteristic variable, classifying the delivery situation into a plurality of cases based on the value set in the work schedule variable, the delivery stage variable, and the delivery destination characteristic variable, and controlling the delivery-specific function differently according to the plurality of cases.

### CROSS-REFERENCE TO RELATED APPLICATION

This application claims priority to and the benefit of Korean Patent Application No. 10-2024-0078307 filed in the Korean Intellectual Property Office on Jun. 17, 2024, the entire contents of which are incorporated herein by reference.

### TECHNICAL FIELD

The disclosure relates to a method and a device for controlling a function of a vehicle, and more specifically, to a method and a device for controlling a function of a vehicle for controlling a delivery-specific function of a vehicle in response to a delivery situation.

### BACKGROUND

As the logistics market expands, there is an active research effort to equip vehicles with delivery-specific functions based on the needs of delivery drivers. In particular, delivery-specific functions are receiving attention as an important function to be installed in purpose built vehicles (PBV), while mass producing PBVs, which are customized vehicles designed for a specific purpose or use. For example, functions, such as cargo temperature control warning (CTCW), which provides an alert when a temperature in a cargo of a vehicle deviates, and smart drive ready (SDR), which automatically starts the vehicle and switches to drive ready when the delivery driver enters the vehicle, are being considered for or installed in PBVs. However, delivery-specific functions may increase your efficiency, but may also not be used in certain situations, or sometimes even interfere with work. In addition, there are many different types of delivery-specific functions, so a specific delivery-specific function may be useful in some situations, while other delivery-specific functions may be not be used. As a result, delicately controlling delivery-specific functions based on real-time changing delivery situations during delivery work would be useful.

### SUMMARY

The present disclosure attempts to provide a method and a device for controlling a function of a vehicle that are capable of controlling a delivery-specific function installed in a vehicle in accordance to a delivery situation.

An example of the present disclosure provides a method of controlling a function of a vehicle that controls a delivery-specific function of a vehicle in accordance with a delivery situation. The method includes receiving vehicle driver's work schedule data, delivery map data, and delivery stage data from a server, allocating a work schedule variable, a delivery stage variable, and a delivery destination characteristic variable in a memory. The method also includes performing a computation based on the work schedule data, the delivery map data, and the delivery stage data to set values in the work schedule variable, the delivery stage variable, and the delivery destination characteristic variable. The method further includes classifying the delivery situation into a plurality of cases based on the value set in the work schedule variable, the delivery stage variable, and the delivery destination characteristic variable. The method also includes controlling the delivery-specific function differently according to the plurality of cases.

In some examples, the delivery-specific function may contain n detailed functions (n is a natural number), and the controlling of the delivery-specific function differently according to the plurality of cases may include setting on or off for each of the n detailed functions according to the plurality of cases.

In some examples, the controlling of the delivery-specific function differently according to the plurality of cases may include setting a preset value for each of the plurality of cases to be associated with each of the cases, and setting an on or off for each of the n detailed functions based on a bitwise value of the preset value.

In some examples, the setting of the values may include acquiring current time, when the current time corresponds to the work schedule data, setting the work schedule variable with a first work schedule value indicating that the driver is on duty, and when the current time does not correspond to the work schedule data, setting the work schedule variable with a second work schedule value indicating that the driver is off duty.

In some examples, the delivery map data may include information about a plurality of zones set on a delivery map, and the setting of the values may include acquiring a current location of the vehicle, and setting the delivery stage variable based on which of the plurality of zones the current location corresponds to.

In some examples, the plurality of zones may include a warehouse zone, a collection zone, and a delivery zone, and the setting of the delivery stage variable may include, when the current location corresponds to the warehouse zone, setting the delivery stage variable with a first delivery stage value indicating that a delivery stage corresponds to a warehouse stage, when the current location corresponds to the collection zone, setting the delivery stage variable with a second delivery stage value indicating that a delivery stage corresponds to a collection zone stage, when the current location corresponds to the delivery zone, setting the delivery stage variable with a third delivery stage value indicating that a delivery stage corresponds to a delivery zone stage, and when the current location does not correspond to the warehouse zone, the collection zone, and the delivery zone, setting the delivery stage variable with a fourth delivery stage value indicating that a delivery stage is a movement to delivery destination stage.

In some examples, the method may further include, when the current location corresponds to the delivery zone, computing delivery zone complexity based on a predetermined reference for the delivery zone, in which the setting of the values may include setting the delivery destination characteristic variable based on the delivery zone complexity.

In some examples, the setting of the delivery destination characteristic variable may include, when the delivery zone complexity is equal to or greater than a first threshold, setting the delivery destination characteristic variable with a first delivery destination characteristic value indicating that complexity of the delivery zone is high, when the delivery zone complexity is less than the first threshold and is equal to or greater than a second threshold, setting the delivery destination characteristic variable with a second delivery destination characteristic value indicating that complexity of the delivery zone is middle, and when the delivery zone complexity is less than the second threshold, setting the delivery destination characteristic variable with a third delivery destination characteristic value indicating that complexity of the delivery zone is low.

In some examples, the computing of the delivery zone complexity may include receiving building coverage ratio data, floor area ratio data, first weighted data determined by reflecting an urban management plan, and second weighted data determined by reflecting traffic information related to the delivery zone, and computing the delivery zone complexity by using at least one of the building coverage ratio data, the floor area ratio data, the first weighted data, and the second weighted data.

In some examples, the computing of the delivery zone complexity may include computing the delivery zone complexity by using the equation of C=T*P(Xc+Xv), where C is the delivery zone complexity, T is the second weighted data, P is the first weighted data, Xc is the building coverage ratio data, and Xv is the floor area ratio data.

Another example of the present disclosure provides a method of controlling a function of a vehicle that controls a delivery-specific function of a vehicle in accordance with a delivery situation. The method includes receiving, from a server, at least one of a work schedule variable, a delivery stage variable, and a delivery destination characteristic variable, each having a value that is computed based on vehicle driver's work schedule data, delivery map data, and delivery stage data and set, classifying the delivery situation into a plurality of cases according to the value set in at least one of the work schedule variable, the delivery stage variable, and the delivery destination characteristic variable, and controlling the delivery-specific function differently according to the plurality of cases.

In some examples, the method may further include, for a variable that is not received from the server among the work schedule variable, the delivery stage variable, and the delivery destination characteristic variable, performing a computation based on the work schedule data, the delivery map data, and the delivery stage data to set a value.

In some examples, the delivery-specific function may contain n detailed functions (n is a natural number), and the controlling of the delivery-specific function differently according to the plurality of cases may include setting on or off for each of the n detailed functions according to the plurality of cases.

In some examples, the controlling of the delivery-specific function differently according to the plurality of cases may include setting a preset value for each of the plurality of cases to be associated with each of the cases, and setting an on or off for each of the n detailed functions based on a bitwise value of the preset value.

Another example of the present disclosure provides a device for controlling a function of a vehicle that controls a delivery-specific function of a vehicle in accordance with a delivery situation, the device executing a program code loaded in one or more memory devices through one or more processors, in which the program code is executed to receive vehicle driver's work schedule data, delivery map data, and delivery stage data from a server, allocate a work schedule variable, a delivery stage variable, and a delivery destination characteristic variable in a memory, perform a computation based on the work schedule data, the delivery map data, and the delivery stage data to set values in the work schedule variable, the delivery stage variable, and the delivery destination characteristic variable, classify the delivery situation into a plurality of cases based on the values set in the work schedule variable, the delivery stage variable, and the delivery destination characteristic variable, and control the delivery-specific function differently according to the plurality of cases.

In some examples, the delivery-specific function may contain n detailed functions (n is a natural number), and the controlling of the delivery-specific function differently according to the plurality of cases may include setting on or off for each of the n detailed functions according to the plurality of cases.

In some examples, the controlling of the delivery-specific function differently according to the plurality of cases may include setting a preset value for each of the plurality of cases to be associated with each of the cases, and setting an on or off for each of the n detailed functions based on a bitwise value of the preset value.

In some examples, the setting of the values may include acquiring current time, and setting the work schedule variable based on whether the current time corresponds to the work schedule data.

In some examples, the delivery map data may include information about a plurality of zones set on a delivery map, and the setting of the values may include acquiring a current location of the vehicle, and setting the delivery stage variable based on which of the plurality of zones the current location corresponds to.

In some examples, the program code may be executed to, when the current location corresponds to the delivery zone among the plurality of zones, additionally compute delivery zone complexity based on a predetermined reference for the delivery zone, and the setting of the values may include setting the delivery destination characteristic variable based on the delivery zone complexity.

### BRIEF DESCRIPTION OF THE DRAWINGS

FIG. 1 is a diagram illustrating a device for controlling a function of a vehicle according to an example embodiment.

FIG. 2 is a diagram illustrating a method of controlling a function of a vehicle according to an example embodiment.

FIG. 3 is a diagram illustrating a method of controlling a function of a vehicle according to an example embodiment.

FIG. 4 is a diagram illustrating an example implementation of the device and the method of controlling the function of the vehicle according to the example embodiment.

FIG. 5 is a diagram illustrating the method of controlling the function of the vehicle according to the example embodiment.

FIG. 6 is a diagram illustrating the method of controlling the function of the vehicle according to the example embodiment.

FIG. 7 is a diagram illustrating the method of controlling the function of the vehicle according to the example embodiment.

FIG. 8 is a diagram illustrating the method of controlling the function of the vehicle according to the example embodiment.

FIGS. 9, 10, and 11 are diagrams illustrating an example implementation of the device and the method of controlling the function of the vehicle according to the example embodiment.

FIG. 12 is a diagram illustrating a computing device according to an example embodiment.

### DETAILED DESCRIPTION

Hereinafter, the present disclosure will be described more fully hereinafter with reference to the accompanying drawings, in which examples of the disclosure are shown. As those skilled in the art would realize, the described examples may be modified in various different ways, all without departing from the spirit or scope of the present disclosure. Accordingly, the drawings and description are to be regarded as illustrative in nature and not restrictive. Like reference numerals designate like elements throughout the specification.

Throughout the specification and the claims, unless explicitly described to the contrary, the word “comprise”, and variations such as “comprises” or “comprising”, will be understood to imply the inclusion of stated elements but not the exclusion of any other elements. Terms including an ordinary number, such as first and second, are used for describing various components, but the components are not limited by the terms. The terms are used only to discriminate one component from another component.

Terms such as “part,” “unit,” “module,” and the like in the specification may refer to a unit capable of processing at least one function or operation described herein, which may be implemented in hardware or circuitry, software, or a combination of hardware or circuitry and software. In addition, at least some of the configurations or functions of a device and a method of controlling a function of a vehicle according to examples described below may be implemented as programs or software, and the programs or software may be stored on a computer-readable medium.

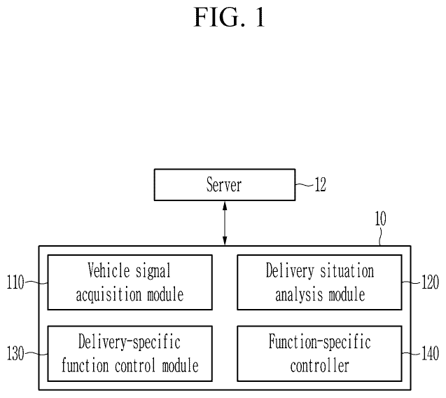

FIG. 1 is a diagram illustrating a device for controlling a function of a vehicle according to an example embodiment.

Referring to FIG. 1, a device 10 for controlling a function of a vehicle according to an example may automatically control a delivery-specific function of a vehicle in accordance with a delivery situation. As the logistics market expands, delivery-specific functions are installed in a vehicle based on the needs of delivery drivers. While these delivery-specific functions may increase work efficiency, the delivery-specific functions are not used in certain situations and sometimes even interfere with work, so it is useful to delicately control the delivery-specific function according to the real-time changing delivery situation during delivery work. To this end, the device 10 for controlling the function of the vehicle may include a vehicle signal acquisition module 110, a delivery situation analysis module 120, a delivery-specific function control module 130, and a function-specific controller 140.

The server 12 may store and manage delivery-related information. For example, as delivery-related information, the server 12 may store and manage information, such as the delivery driver's working hours, a map of the delivery zone, the delivery destination characteristic, the time (e.g., required) for the work, the average driving speed, the number of accidents, and the like. The device 10 for controlling the function of the vehicle may perform communication by transmitting information, such as driver identification information, driving time, and the time (e.g., required) for the work, to the server 12 via a network, and receiving a response from the server 12 in response to the transmission of the information. In this specification, examples have been described assuming that the driver is a delivery driver in a situation where a delivery occurs, so the term “delivery driver” and the term “driver” may be used interchangeably (e.g., understood as different expressions of the same concept).

In some examples, the device 10 for controlling the function of the vehicle may transmit information, such as driver identification information, to the server 12 and, in response to the transmission of the information, receive work schedule data, delivery map data, and delivery stage data for the delivery driver from the server 12. The device 10 for controlling the function of the vehicle may allocate the work schedule variable, the delivery stage variable, and the delivery destination characteristic variable in the memory, and may perform a computation based on the work schedule data, the delivery map data, and the delivery stage data received from the server 12 to set values to the work schedule variable, the delivery stage variable, and the delivery destination characteristic variable. Then, the device 10 for controlling the function of the vehicle may classify the delivery situation into a plurality of cases according to the values set to the work schedule variable, the delivery stage variable, and the delivery destination characteristic variable, and may control the delivery-specific functions differently according to the plurality of cases. In other words, the device 10 for controlling the function of the vehicle may receive (e.g., only) basic information from the server 12 and make a detailed determination about the delivery situation (e.g., directly).

In some other examples, the device 10 for controlling the function of the vehicle may transmit information, such as driver identification information, to the server 12, and may receive at least one of a work schedule variable, a delivery stage variable, and a delivery destination characteristic variable from the server 12 in response to the transmission of the information. Here, at least one of the work schedule variable, the delivery stage variable, and the delivery destination characteristic variable may be a value set by performing a computation by the server 12 based on the vehicle driver's work schedule data, the delivery map data, and the delivery stage data, respectively. Subsequently, the device 10 for controlling the function of the vehicle may classify the delivery situation into a plurality of cases according to the values set to at least one of the work schedule variable, the delivery stage variable, and the delivery destination characteristic variable received from the server 12, and may control the delivery-specific functions differently according to the plurality of cases. In other words, the device 10 for controlling the function of the vehicle may receive a result of completing at least one detailed determination of the delivery situation from the server 12. In some examples, the device 10 for controlling the function of the vehicle may set values (e.g., directly) by performing a computation based on the work schedule data, the delivery map data, and the delivery stage data, when one or more variables are not received from the server 12, such as the work schedule variable, the delivery stage variable, and the delivery destination characteristic variable.

The vehicle signal acquisition module 110 may acquire signals indicative of the global positioning system (GPS) location of the vehicle, the speed of the vehicle, gear stage information, power status, and the like. The vehicle signal acquisition module 110 may provide these acquired signals to the delivery situation analysis module 120.

The delivery situation analysis module 120 may classify the delivery situation into a plurality of cases based on values set to the work schedule variable, the delivery stage variable, and the delivery destination characteristic variable.

In some examples, the device 10 for controlling the function of the vehicle or the server 12 may set the values of the work schedule variables by performing a computation based on the work schedule data. Here, the work schedule data may include information, such as the delivery driver's work hours and work days stored and managed by the server 12. Specifically, the device 10 for controlling the function of the vehicle or the server 12 may acquire the current time and, when the current time corresponds to the work schedule data, set the work schedule variable with a first work schedule value indicating that the driver is on duty, and, when the current time does not correspond to the work schedule data, set the work schedule variable with a second work schedule value indicating that the driver is off duty. The delivery situation analysis module 120 may classify the delivery situation as “on duty” or “off duty” based on the values set for the work schedule variables set as described above, and treat the classified delivery situation as a first key factor.

In some examples, the device 10 for controlling the function of the vehicle or the server 12 may set the value of the delivery stage variable by performing a computation based on the delivery map data. Specifically, the device 10 for controlling the function of the vehicle or the server 12 may set the value of the delivery stage variable by performing a computation based on delivery map data. Here, the delivery map data may include information regarding a plurality of zones set on the delivery map. Specifically, the device 10 for controlling the function of the vehicle or the server 12 may acquire a current location of the vehicle and set the delivery stage variable based on which of the plurality of zones the current location corresponds to.

In some examples, the plurality of zones may include a warehouse zone, a collection zone, and a delivery zone. Herein, the warehouse zone may be a place where loading and unloading operations are performed for a large volume of parcels, and the collection zone may be a place where there is a high probability in that a large volume of parcels is loaded and unloaded and where there is a high probability in that the delivery driver enters the vehicle with not-empty hands due to picking up parcels. On the other hand, the delivery zone may represent a place where there is a high probability in that a small amount of parcels per destination is delivered, where getting in and getting off of the delivery vehicle frequently occur, and where there is a high probability in that the delivery driver visits residential or commercial complexes. The device 10 for controlling the function of the vehicle or the server 12 may set the delivery stage variable with a first delivery stage value indicating that the delivery stage is a warehouse stage when the current location corresponds to a warehouse zone, and set the delivery stage variable with a second delivery stage value indicating that the delivery stage is a collection zone stage when the current location corresponds to a collection zone. On the other hand, the device 10 for controlling the function of the vehicle or the server 12 may set the delivery stage variable with a third delivery stage value indicating that the delivery stage is a delivery zone stage when the current location corresponds to a delivery zone, and set the delivery stage variable with a fourth delivery stage value indicating that the delivery stage is a movement to delivery destination stage when the current location does not correspond to a warehouse zone, a collection zone, and a delivery zone. The delivery situation analysis module 120 may classify the delivery situation into a “warehouse stage”, a “movement to delivery destination stage”, a “delivery zone stage”, or a “delivery zone” based on the value set to the delivery stage variable set as described above, and treat the classified delivery situation as a second key factor.

In some examples, when the current location corresponds to a delivery zone, the device 10 for controlling the function of the vehicle or the server 12 may compute delivery zone complexity based on a predetermined reference for the delivery zone, and set a delivery destination characteristic variable based on the computed delivery zone complexity. Specifically, the device 10 for controlling the function of the vehicle or the server 12 may set the delivery destination characteristic variable with a first delivery destination characteristic value indicating that the complexity of the delivery zone is high when the delivery zone complexity is equal to or greater than a first threshold, set the delivery destination characteristic variable with a second delivery destination characteristic value indicating that the complexity of the delivery zone is middle when the delivery zone complexity is less than the first threshold and is equal to or greater than a second threshold, and set the delivery destination characteristic variable with a third delivery destination characteristic value indicating that the complexity of the delivery zone is low when the delivery zone complexity is less than the second threshold. The delivery situation analysis module 120 may classify the delivery situation as “High,” “Mid,” or “Low” based on the value set for the delivery destination characteristic variable set as described above, and treat the classified delivery situation as a third key factor.

In some examples, the device 10 for controlling the function of the vehicle or the server 12 may be provided with building coverage ratio data, floor area ratio data, first weighted data determined by using (e.g., reflecting) an urban management plan, and second weighted data determined by reflecting traffic information related to the delivery zone, and compute the delivery zone complexity by using at least one of the building coverage ratio data, the floor area ratio data, the first weighted data, and the second weighted data. Here, the building coverage ratio is the ratio of the building area to the land area, the floor area ratio is the percentage of the total area of the building to the land area, the urban management plan is a statutory plan established to promote sustainable development of the city by harmonizing the functions of the city, and the traffic information may be the traffic flow status of the main roads delivered through the national transportation information center (ITS). In the present example, as the building coverage ratio is higher, the area may be determined to be an area where parking is complicated or congested, and as the floor area ratio is higher, the area may be determined to be an area with a high flow of people. On the other hand, in the case of an urban management plan, a use area or city area designated by the National Land Planning Act may be weighted in the computation of the complexity of the delivery zone, and with respect to traffic information, road traffic information of a specific area in real time may be reflected in the computation of the delivery zone complexity.

In some examples, the device 10 for controlling the function of the vehicle or the server 12 may compute the delivery zone complexity by using the following Equation 1.

$$C = T * P ( {X}_{c} + {X}_{v} ) \qquad ( Equation 1 )$$

Herein, C is the delivery zone complexity, T is the second weighted data, P is the first weighted data, X_{c} is the building coverage ratio data, and Xᵥ is the floor area ratio data. Table 1 to Table 3 below show example values for C, P, and T values.

TABLE 1

| Road type | Traffic speed | T |
|---|---|---|
| Expressway | 80 km/h or more | 1 |
| | 40~80 km/h | 1.5 |
| | Less than 40 km/h | 2 |
| National highway | 50 km/h or more | 1 |
| | 30~50 km/h | 1.5 |
| | Less than 30 km/h | 2 |
| Local road | 50 km/h or more | 1 |
| | 30~50 km/h | 1.5 |
| | Less than 30 km/h | 2 |
| General road | 25 km/h or more | 1 |
| | 15~25 km/h | 1.5 |
| | Less than 15 km/h | 2 |

TABLE 2

| Use area | P |
|---|---|
| City area (Residential area) | 4 |
| City area (Industrial area) | 3 |
| City area (Commercial area) | 5 |
| City area (Green area) | 2 |
| Agricultural area | 1 |
| Natural environment conservation area | 1 |
| Management area | 2 |

TABLE 3

| Delivery destination | |
|---|---|
| characteristic (complexity) | C |
| High | 20 or more |
| Mid | 5 or more and less than 20 |
| Low | Less than 5 |

For example, for a general road in a commercial area with an average traffic speed of 50 km/h, a building coverage ratio of 85%, and a floor area ratio of 700%, the delivery zone complexity may be computed as 4(0.85+7)=31.4 (High). As another example, for a general national road in an industrial area with an average traffic speed of 35 km/h, a building coverage ratio of 70%, and a floor area ratio of 300%, the delivery zone complexity may be computed as 1.5*3 (0.7+3)=11.1 (Mid). As another example, for an expressway in an agricultural area with an average traffic speed of 100 km/h, a building coverage ratio of 20%, and a floor area ratio of 80%, the delivery zone complexity may be computed as 1 (0.2+0.8)=1 (Low).

The delivery-specific function control module 130 may control the delivery-specific function differently based on a plurality of cases classified by the delivery situation analysis module 120.

In some examples, the delivery-specific function may include n detailed functions, where n is a natural number. Examples of detailed functions include: cargo collision warning (CCW), cargo temperature control warning (CTCW), smart walk away (SWA), smart drive ready (SDR), cargo door warning (CDW), cargo auto brake (CAB), smart cargo collision warning (S-CCW), smart temperature control (STC), safe zone assistance (SZA), auto cargo leveling (ACL), smart walk in (SWI), cargo ventilation system (CVS), smart power save (SPS), and cargo weight monitoring (CWM).

CCW may be a function of warning a collision with a top end or a rear face of the vehicle's cargo by utilizing an ultrasonic sensor, CTCW may be a function of providing an alert when the temperature in the vehicle's cargo deviates, SWA may be a function of automatically closing or locking the cargo door when the delivery driver walks away from the vehicle, SDR may be a function of starting the vehicle when the delivery driver enters the vehicle and automatically switching the vehicle to drive ready, and CDW may be a function of transmitting an alert when the driver drives with the cargo door open. In the meantime, CAB may be a function of engaging the parking brake or shifting the gear stage into P stage when the driver exits, S-CCW may be a function of warning a collision on the top end or the rear face of the cargo by varying a detection reference level of the ultrasonic sensor depending on the vehicle's position, STC may be a function of automatically setting the temperature of the cargo according to logistics features, SZA may be a function of limiting the speed of the vehicle when the vehicle enters a protected zone, recording an image, and monitoring the speed, ACL may be a function of adjusting the height of the cargo, SWI may be a function of automatically opening the cargo door when a delivery driver is approaching the vehicle, CVS may be a function of providing ventilation inside the cargo, SPS may be a function of automatically turning off the vehicle when the vehicle has not been driven for a period of time, and CWM may be a function of notifying a warning that the vehicle is unable to drive when the loaded weight exceeds a reference value.

The delivery-specific function control module 130 may set each of the n detailed functions with on or off according to the plurality of cases. Specifically, for each of the plurality of cases, the delivery-specific function control module 130 may set a preset value Preset_Val associated with each case, and may set each of the n detailed functions with on or off based on a bitwise value of the preset value. Table 4 below shows examples of case characteristics and preset values.

TABLE 4

| Key Factor | | | | |
|---|---|---|---|---|
| | | Delivery | | |
| | | destination | | |
| Work | Delivery | character- | | Preset_{—} |
| schedule | stage | istic | Characteristic | Val |
| On duty | Warehouse | Irrelevant | High volume loading | 12753 |
| | | | and unloading | |
| | | | operations | |
| | Movement to | Irrelevant | Possibility for | 13300 |
| | delivery | | accidents while | |
| | destination | | driving | |
| | Collection | High | Difficult parking | 13819 |
| | zone | | High floating | |
| | | | population | |
| | | Mid | Possibility of theft | 14331 |
| | | Low | Quiet area | 14335 |
| | | | Possibility of theft | |
| | Delivery | High | Difficult parking | 15858 |
| | zone | | High floating | |
| | | | population | |
| | | Mid | Possibility of theft | 16370 |
| | | Low | Quiet area | 16374 |
| | | | Possibility of theft | |
| Off duty | Irrelevant | Irrelevant | Not driving for long | 10128 |
| | | | periods of time | |

The function-specific controller 140 may read the preset value set by the delivery-specific function control module 130 according to a bit, and perform an on or off setting for each delivery-specific function based on the read value.

According to the example, it is possible to automatically turn on/off delivery-specific functions installed on the vehicle, or suggest turning on/off of the delivery-specific function to the driver, in consideration of real-time changing delivery situations during delivery work, based on the key factors, such as the delivery driver's work schedule, delivery stage, and delivery destination characteristic. By controlling the delivery-specific functions installed in the vehicle based on the delivery situation, it is possible to set the functions that are no longer used (e.g., needed) in a real-time delivery situation or are disruptive to the work to be off, and set (e.g., only) the used (e.g., required) functions to be on, to implement delicate dedicated function control.

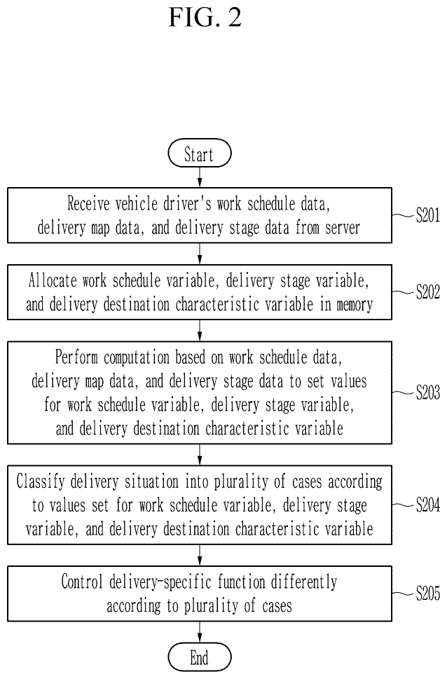

FIG. 2 is a diagram illustrating a method of controlling a function of a vehicle according to an example embodiment.

Referring to FIG. 2, a method of controlling a function of a vehicle according to an example includes receiving a vehicle driver's work schedule data, delivery map data, and delivery stage data from a server (S201), allocating a work schedule variable, a delivery stage variable, and a delivery destination characteristic variable in a memory (S202), performing a computation based on the work schedule data, the delivery map data, and the delivery stage data to set values for the work schedule variable, the delivery stage variable, and the delivery destination characteristic variable (S203), classifying a delivery situation into a plurality of cases according to the values set for the work schedule variable, the delivery stage variable, and the delivery destination characteristic variable (S204), and controlling a delivery-specific function differently for the plurality of cases (S205).

For further details of the above methods, reference may be made to the examples described herein, so that duplicative description is omitted herein.

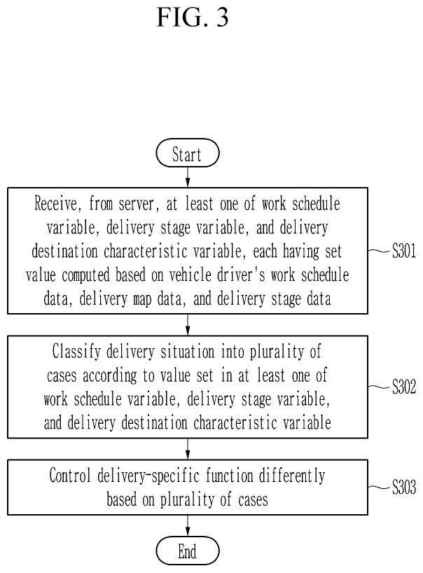

FIG. 3 is a diagram illustrating a method of controlling a function of a vehicle according to an example embodiment.

Referring to FIG. 3, a method of controlling a function of a vehicle according to an example may include receiving, from a server, at least one of a work schedule variable, a delivery stage variable, and a delivery destination characteristic variable, each having a set value computed based on vehicle driver's work schedule data, delivery map data, and delivery stage data (S301), classifying the delivery situation into a plurality of cases according to the value set in at least one of the work schedule variable, the delivery stage variable, and the delivery destination characteristic variable (S302), and controlling a delivery-specific function differently based on the plurality of cases (S303).

For further details of the above methods, reference may be made to the examples described herein, so that duplicative description is omitted herein.

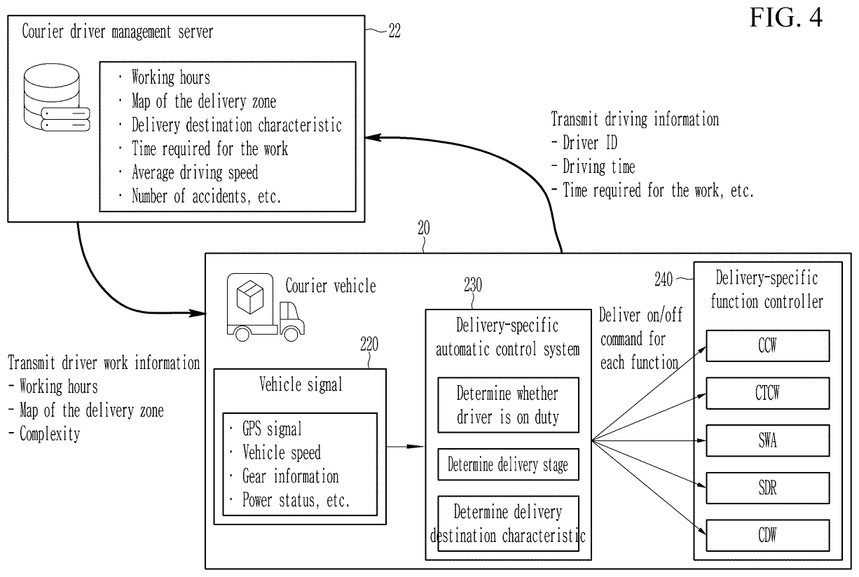

FIG. 4 is a diagram illustrating an example implementation of the device and the method of controlling the function of the vehicle according to the example embodiment.

Referring to FIG. 4, in one implementation example, a courier vehicle 20 and a courier driver management server 22 may exchange data over a network to automatically control a delivery-specific function of the courier vehicle 20 in response to a delivery situation.

The courier driver management server 22 may correspond to the server 12 previously described with reference to FIG. 1. The courier driver management server 22 may store and manage information about the courier driver as delivery-related information. Specifically, the courier driver management server 22 may store and manage information, such as the courier driver's working hours, a map of the delivery zone, the delivery destination characteristic, time (e.g., required) for the work, an average driving speed, the number of accidents, and the like.

The courier vehicle 20 may transmit information, such as driver identification information, driving time, and time (e.g., required) for the work, to the courier driver management server 22 as driving information via the network, and in response to the transmission of the driving information, receive information, such as working hours, the map of the delivery zone, and complexity, from the courier driver management server 22 as driver work information.

The courier vehicle 20 may acquire a vehicle signal 220 including GPS signals, a vehicle speed, gear information, and a power status, and the like. A delivery-specific automatic control system 230 may classify the delivery situation into a plurality of cases by determining the work status, delivery stage, and delivery destination characteristic according to the values set to the work schedule variable, the delivery stage variable, and the delivery destination characteristic variable, and may deliver a function-specific on/off command to the delivery-specific function controller 240 in the form of a preset value Preset_Val. Subsequently, the delivery-specific function controller 240 may read the preset value and set it on or off for each of CCW, CTCW, SWA, SDR, and CDW.

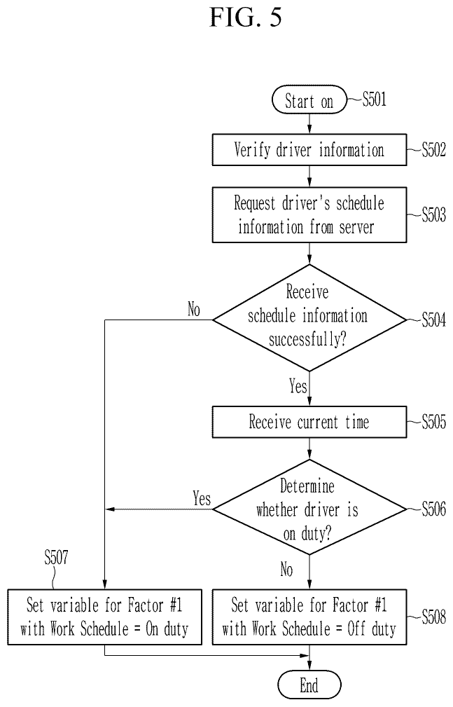

FIG. 5 is a diagram illustrating the method of controlling the function of the vehicle according to the example embodiment.

Referring to FIG. 5, the method of controlling the function of the vehicle according to the example may include starting a vehicle (S501), after the vehicle is started, identifying a driver of the vehicle and verifying driver information (S502), requesting driver's schedule information from a server by using the driver identification information (S503), and determining whether the driver's schedule information is successfully received from the server (S504).

When it is determined that the driver's schedule information has been successfully received from the server (S504, Yes), the method may perform receiving the current time (S505), and comparing the current time to scheduled working time to determine whether the driver is on duty (S506). In some examples, the current time may be acquired from a GPS time provided via a navigation device of the vehicle, or may be acquired by receiving a server time.

When it is determined that the driver's schedule information was not properly received from the server (S504, No) or when it is determined that the current time is within the scheduled working time and the driver is on duty (S506, Yes), the method may perform setting a variable for a first key factor Factor #1 with “Work Schedule=On duty” (S507). In contrast, when it is determined that the current time is outside of the scheduled working time and the driver is off duty (S506, No), the method may perform setting a variable for the first key factor Factor #1 with “Work Schedule=Off duty” (S508).

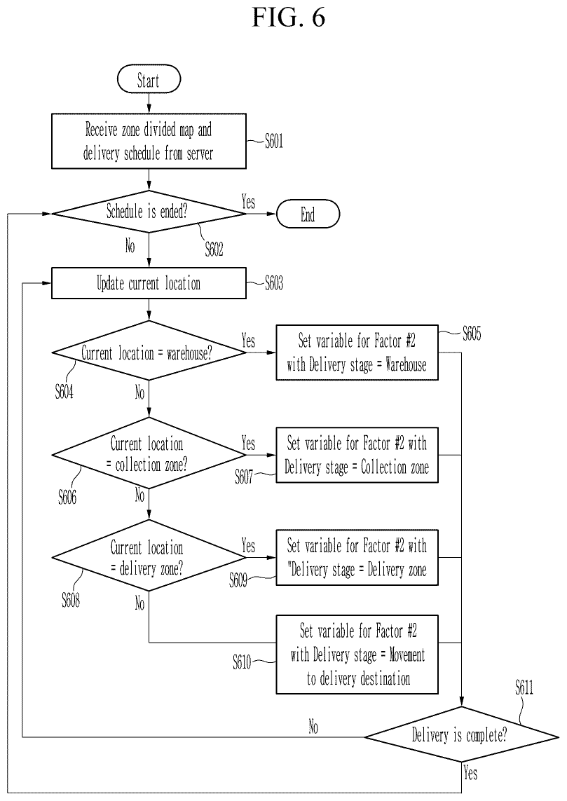

FIG. 6 is a diagram illustrating the method of controlling the function of the vehicle according to the example embodiment.

Referring to FIG. 6, the method of controlling the function of the vehicle according to the example may include receiving a zone divided map and a delivery schedule from the server (S601), and determining whether the delivery schedule has ended (S602). When it is determined that the delivery schedule has ended (S602, Yes), the method may end (e.g., be terminated).

When it is determined that the delivery schedule has not ended (S602, No), the method may perform updating the current location of the vehicle (S603) and determining that the current location of the vehicle is a warehouse (S604). When it is determined that the current location of the vehicle is the warehouse (S604, Yes), the method may perform setting a variable for a second key factor Factor #2 with “Delivery stage=Warehouse” (S605).

When it is determined that the current location of the vehicle is not a warehouse (S604, No), the method may perform determining whether the current location of the vehicle is a collection zone (S606). When it is determined that the current location of the vehicle is an collection zone (S606, Yes), the method may perform setting the variable for the second key factor Factor #2 with “Delivery stage=Collection zone” (S607).

When it is determined that the current location of the vehicle is not a collection zone (S606, No), the method may perform determining whether the current location of the vehicle is a delivery zone (S608). When it is determined that the current location of the vehicle is the delivery zone (S608, Yes), the method may perform setting a variable for the second key factor Factor #2 with “Delivery stage=Delivery zone” (S609). When it is determined that the current location of the vehicle is not a delivery zone (S608, No), the method may perform setting a variable for the second key factor Factor #2 with “Delivery stage=Movement to delivery destination” (S610).

After performing any one of the operations, operation S605, operation S607, operation S609, and operation S610, the method may perform determining whether the delivery is complete (S611). When it is determined that the delivery is complete, the method may proceed to operation S602. When it is determined that the delivery is not complete, the method may proceed to operation S603.

In some examples, the zone divided map may be a map in which the vicinity of the delivery destination is set to, for example, a geo-fence zone, and the current location of the vehicle may be a GPS location provided via a vehicle navigation device. Accordingly, it may be determined whether the vehicle has currently entered a geo-fence zone and the like. For example, the geo-fence may be set to correspond to a warehouse, a collection zone, a delivery zone, or the like.

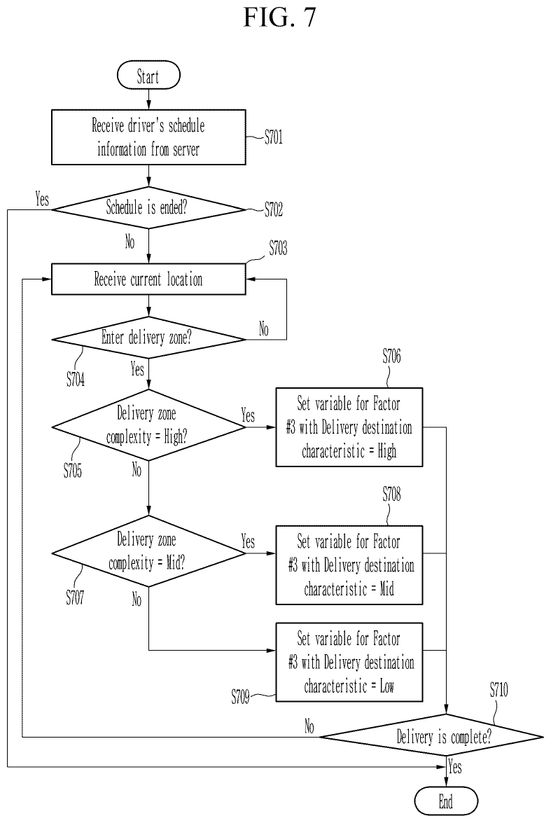

FIG. 7 is a diagram illustrating the method of controlling the function of the vehicle according to the example embodiment.

Referring to FIG. 7, the method of controlling the function of the vehicle according to the example may include receiving driver's schedule information from the server (S701) and determining whether a delivery schedule has ended (S702). When it is determined that the delivery schedule has ended (S702, Yes), the method may end (e.g., be terminated).

When it is determined that the delivery schedule has not ended (S702, No), the method may include (e.g., perform) receiving the current location of the vehicle (S703) and determining whether the vehicle has entered the delivery zone (S704). When it is determined that the vehicle has not entered the delivery zone (S704, No), the method may proceed to operation S703.

When it is determined that the vehicle has entered the delivery zone (S704, Yes), the method may perform determining whether delivery zone complexity is “High” (S705). The delivery zone complexity may be computed as one of “High”, “Mid”, and “Low” as previously described with reference to FIG. 1. When it is determined that the delivery zone complexity is “High” (S705, Yes), the method may perform setting a variable for a third key factor Factor #3 with “Delivery destination characteristic=High” (S706).

When it is determined that the delivery zone complexity is not “High” (S705, No), the method may perform determining whether the delivery zone complexity is “Mid” (S707). When it is determined that the delivery zone complexity is “Mid” (S707, Yes), the method may perform setting a variable for the third key factor Factor #3 with “Delivery destination characteristic=Mid” (S708). When it is determined that the delivery zone complexity is not “Mid” (S707, No), the method may perform setting the variable for the third key factor Factor #3 with “Delivery destination characteristic=Low” (S709).

After performing any one of the operations, operation S706, operation S708, and operation S709, the method may perform determining whether the delivery is complete (S710). When it is determined that the delivery is complete, the method may end (e.g., terminate). When it is determined that the delivery is not complete, the method may proceed to operation S703.

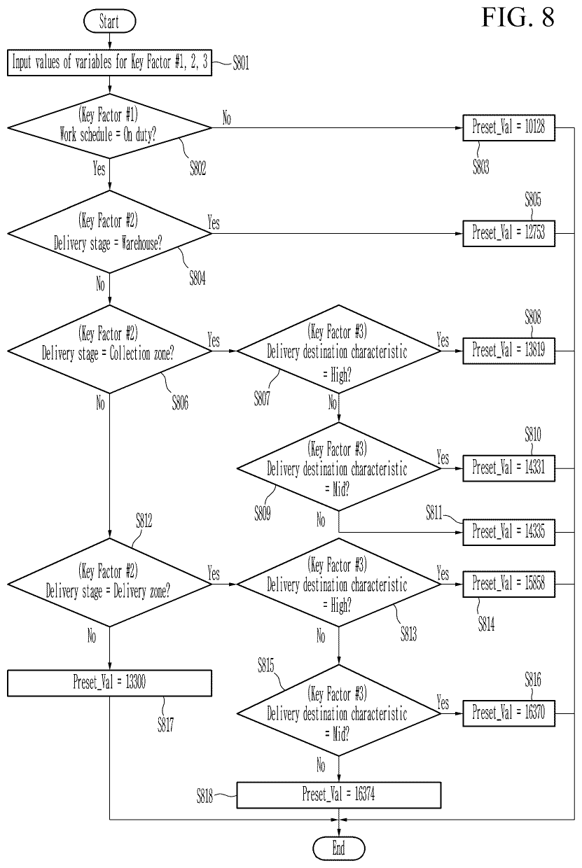

FIG. 8 is a diagram illustrating the method of controlling the function of the vehicle according to the example embodiment.

Referring to FIG. 8, in one example, the method of controlling the function of the vehicle may include receiving input of the values of the variables for the first key factor Factor #1, the second key factor Factor #2, and the third key factor Factor #3 (S801) and verifying that a value of a work schedule for the first key factor Factor #1 is on duty (S802). When it is determined that the value of the work schedule for the first key factor Factor #1 is off duty (S802, No), the method may perform setting the preset value Preset_Val with 10128 (S803). Here, the preset value Preset_Val indicated in operation S803 is an example (e.g., only) and is not intended to limit the scope of the disclosure. The same applies to the subsequent operations, such as operations S805, S808, S810, S811, S814, S816, S817, and S818 (e.g., the values indicated in these operations also are examples and not intended to limit the scope of the disclosure).

When the value of the work schedule for the first key factor Factor #1 is determined to be on duty (S802, Yes), the method may perform determining whether the value of the delivery stage for the second key factor Factor #2 is a warehouse (S804). When it is determined that the value of the delivery stage for the second key factor Factor #2 is the warehouse (S804, Yes), the method may perform setting the preset value Preset_Val with 12753 (S805).

When it is determined that the value of the delivery stage for the second key factor Factor #2 is not a warehouse (S804, No), the method may perform determining whether the value of the delivery stage for the second key factor Factor #2 is a collection zone (S806). When it is determined that the value of the delivery stage for the second key factor Factor #2 is the collection zone (S806, No), the method may perform determining whether a value of a delivery destination characteristic for the third key factor Factor #3 is High (S807). When it is determined that the value of the delivery destination characteristic for the third key factor Factor #3 is High (S807, Yes), the method may perform setting the preset value Preset_Val with 13819 (S808).

When it is determined that the value of the delivery destination characteristic for the third key factor Factor #3 is not High (S807, No), the method may perform determining whether the value of the delivery destination characteristic for the third key factor Factor #3 is Mid (S809). When it is determined that the value of the delivery destination characteristic for the third key factor Factor #3 is Mid (S809, Yes), the method may perform setting the preset value Preset_Val with 14331 (S810). When it is determined that the value of the delivery destination characteristic for the third key factor Factor #3 is not Mid (S809, No), the method may perform setting the preset value Preset_Val with 14335 (S811).

When it is determined that the value of the delivery stage for the second key factor Factor #2 is not a collection zone (S806, no), the method may perform determining whether the value of the delivery stage for the second key factor Factor #2 is a delivery zone (S812). When it is determined that the value of the delivery stage for the second key factor Factor #2 is the delivery zone (S812, Yes), the method may perform determining whether the value of the delivery destination characteristic for the third key factor Factor #3 is High (S813). When it is determined that the value of the delivery destination characteristic for the third key factor Factor #3 is High (S813, Yes), the method may perform setting the preset value Preset_Val with 15858 (S814).

When it is determined that the value of the delivery destination characteristic for the third key factor Factor #3 is not High (S813, No), the method may perform determining whether the value of the delivery destination characteristic for the third key factor Factor #3 is Mid (S815). When it is determined that the value of the delivery destination characteristic for the third key factor Factor #3 is Mid (S815, Yes), the method may perform setting the preset value Preset_Val with 16370 (S816). When it is determined that the value of the delivery destination characteristic for the third key factor Factor #3 is not Mid (S815, No), the method may perform setting the preset value Preset_Val with 16374 (S818).

When it is determined that the value of the delivery stage for the second key factor Factor #2 is the delivery zone (S812, No), the method may perform setting the preset value Preset_Val with 13300 (S817).

According to the present example, the delivery-specific function of the vehicle may be controlled based on the preset values that represent the number of cases when the three key factors, the first key factor Factor #1, the second key factor Factor #2, and the third key factor Factor #3, are combined. Here, the preset value may be a determined on/off value for each of a plurality of delivery-specific functions.

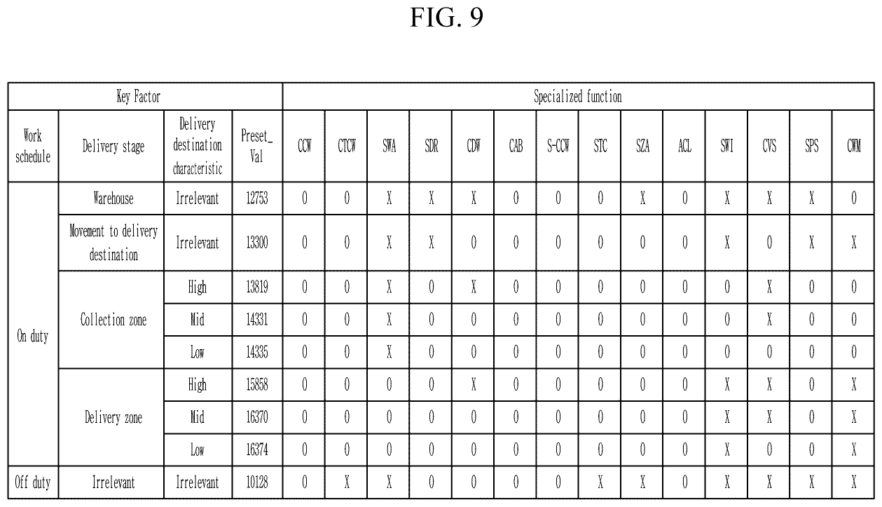

FIGS. 9 to 11 are diagrams illustrating an example implementation of the device and the method of controlling the function of the vehicle according to the example embodiment.

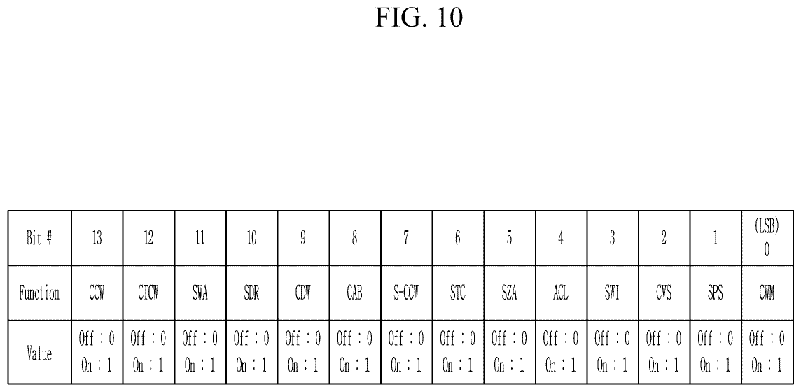

Referring to FIG. 9 and FIG. 10 together, an example implementation of the preset values and the on/off values for delivery-specific functions, including 14 detailed functions, such as CCW, CTCW, SWA, SDR, CDW, CAB, S-CCW, STC, SZA, ACL, SWI, CVS, SPS, and CWM, are shown. The preset value may be represented as a binary number with 14 bits, each bit may have information about whether it is on or off for a detailed function, for example, information indicating that when a bit value is 0, the delivery-specific function is set to off, and when a bit value is 1, the delivery-specific function is set to on.

For example, for a preset value of 13300, the delivery-specific functions may be controlled so that CCW, CTCW, CDW, CAB, S-CCW, STC, SZA, ACL, and CVS are set to on, and SWA, SDR, SWI, SPS, and CWM are set to off. As another example, for a preset value of 15858, the delivery-specific functions may be controlled so that CCW, CTCW, SWA, SDR, CAB, S-CCW, STC, SZA, ACL, and SPS are set to on, and CDW, SWI, CVS, and CWM are set to off.

With respect to these detailed functions, depending on the model or the options of the vehicle, at least some of the functions listed in the implementation example may be deleted, or other new functions not listed in the implementation example may be added.

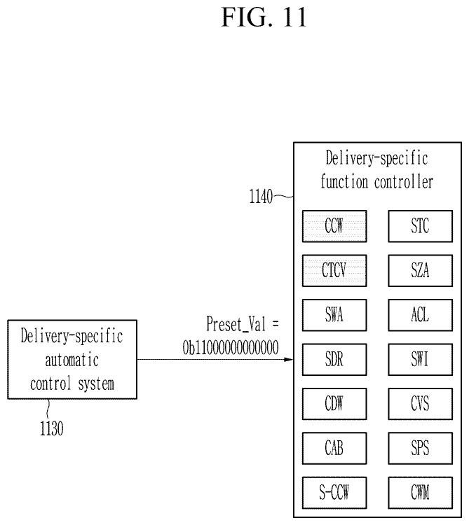

Referring to FIG. 11, in the present implementation example, when a delivery-specific automatic control system 1130 has computed the preset value to be 0b11000000000000, a delivery-specific function controller 1140 may read the preset value according to bit and, based on a result of the reading, set (e.g., only) CCW and CTCV to be on and set the remaining SWA, SDR, CDW, CAB, S-CCW, STC, SZA, ACL, SWI, CVS, SPS, and CWM to be off.

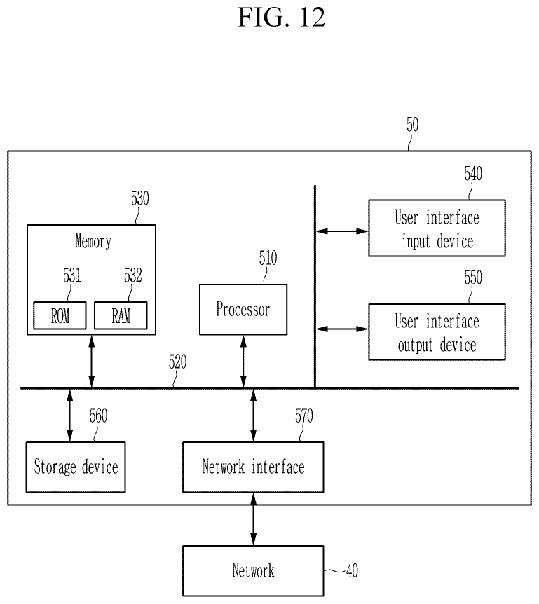

FIG. 12 is a diagram illustrating a computing device according to an example embodiment.

Referring now to FIG. 12, the method and the device for controlling the function of the vehicle according to the examples may be implemented by using a computing device 50.

The computing device 50 may include at least one of a processor 510, a memory 530, a user interface input device 540, a user interface output device 550, and a storage device 560 communicating via a bus 520. The computing device 50 may also include a network interface 570 electrically connected to the network 40. The network interface 570 may transmit or receive a signal with another entity through the network 40.

The processor 510 may be implemented in various types, such as a micro controller unit (MCU), application processor (AP), a central processing unit (CPU), a graphic processing unit (GPU), a neutral processing unit (NPU), and a quantum processing unit (QPU), and may be a predetermined semiconductor device executing commands stored in the memory 530 or the storage device 560. The processor 510 may be configured to implement the function and the methods described above with reference to FIGS. 1 to 11.

The memory 530 and the storage device 560 may include various forms of volatile or non-volatile storage media. For example, the memory may include a read only memory (ROM) 531 and a random access memory (RAM) 532. In some examples, the memory 530 may be located inside or outside the processor 510, and the memory 530 may be connected with the processor 510 (e.g., through any suitable manner).

In some examples, at least some configurations or functions of the method and the device for controlling the function of the vehicle according to the examples may be implemented as programs or software executed on the computing device 50, and the programs or software may be stored on a computer-readable medium. Specifically, a computer-readable medium according to the example may record a program for executing the operations included in an implementation of the method of controlling the function of the vehicle according to the example on a computer including the processor 510 executing a program or commands stored in the memory 530 or the storage device 560.

In some examples, at least some configurations or functions of the method and the device for controlling the function of the vehicle according to the examples may be implemented using hardware or circuit of the computing device 50 or may be implemented as separate hardware or circuit that may be electrically connected to computing device 50.

According to the examples, it is possible to (e.g., automatically) turn on/off delivery-specific functions installed on the vehicle, or suggest turning on/off of the delivery-specific function to the driver, in consideration of real-time changing delivery situations during delivery work, based on the key factors, such as the delivery driver's work schedule, delivery stage, and delivery destination characteristic.

Although the above examples of the present disclosure have been described in detail, the scope of the present disclosure is not limited thereto, but also includes various modifications and improvements by one of ordinary skill in the art utilizing the basic concepts of the present disclosure as defined in the following claims.

What is claimed is:

1. A method of controlling a function of a vehicle that controls a delivery-specific function of a vehicle in accordance with a delivery situation, the method comprising:
receiving vehicle driver's work schedule data, delivery map data, and delivery stage data from a server;
allocating a work schedule variable, a delivery stage variable, and a delivery destination characteristic variable in a memory;
performing a computation based on the work schedule data, the delivery map data, and the delivery stage data to set values in the work schedule variable, the delivery stage variable, and the delivery destination characteristic variable;
classifying the delivery situation into a plurality of cases based on the value set in the work schedule variable, the delivery stage variable, and the delivery destination characteristic variable; and
controlling the delivery-specific function differently according to the plurality of cases.

2. The method of claim 1, wherein
the delivery-specific function contains n detailed functions, wherein n is a natural number, and
the controlling of the delivery-specific function differently according to the plurality of cases includes
setting on or off for each of the n detailed functions according to the plurality of cases.

3. The method of claim 2, wherein
the controlling of the delivery-specific function differently according to the plurality of cases includes:
setting a preset value for each of the plurality of cases to be associated with each of the cases; and
setting an on or off for each of the n detailed functions based on a bitwise value of the preset value.

4. The method of claim 1, wherein
the setting of the values includes:
acquiring current time;
when the current time corresponds to the work schedule data, setting the work schedule variable with a first work schedule value indicating that the driver is on duty; and
when the current time does not correspond to the work schedule data, setting the work schedule variable with a second work schedule value indicating that the driver is off duty.

5. The method of claim 1, wherein
the delivery map data includes information about a plurality of zones set on a delivery map, and
the setting of the values includes:
acquiring a current location of the vehicle; and
setting the delivery stage variable based on which of the plurality of zones the current location corresponds to.

6. The method of claim 5, wherein
the plurality of zones includes a warehouse zone, a collection zone, and a delivery zone, and
the setting of the delivery stage variable includes:
when the current location corresponds to the warehouse zone, setting the delivery stage variable with a first delivery stage value indicating that a delivery stage corresponds to a warehouse stage;
when the current location corresponds to the collection zone, setting the delivery stage variable with a second delivery stage value indicating that a delivery stage corresponds to a collection zone stage;
when the current location corresponds to the delivery zone, setting the delivery stage variable with a third delivery stage value indicating that a delivery stage corresponds to a delivery zone stage; and
when the current location does not correspond to the warehouse zone, the collection zone, and the delivery zone, setting the delivery stage variable with a fourth delivery stage value indicating that a delivery stage is a movement to delivery destination stage.

7. The method of claim 6, further comprising,
when the current location corresponds to the delivery zone, computing delivery zone complexity based on a predetermined reference for the delivery zone,
wherein the setting of the values includes
setting the delivery destination characteristic variable based on the delivery zone complexity.

8. The method of claim 7, wherein
the setting of the delivery destination characteristic variable includes:
when the delivery zone complexity is equal to or greater than a first threshold, setting the delivery destination characteristic variable with a first delivery destination characteristic value indicating that complexity of the delivery zone is high;
when the delivery zone complexity is less than the first threshold and is equal to or greater than a second threshold, setting the delivery destination characteristic variable with a second delivery destination characteristic value indicating that complexity of the delivery zone is middle;
when the delivery zone complexity is less than the second threshold, setting the delivery destination characteristic variable with a third delivery destination characteristic value indicating that complexity of the delivery zone is low.

9. The method of claim 7, wherein
the computing of the delivery zone complexity includes:
receiving building coverage ratio data, floor area ratio data, first weighted data determined by reflecting an urban management plan, and second weighted data determined by reflecting traffic information related to the delivery zone; and
computing the delivery zone complexity by using at least one of the building coverage ratio data, the floor area ratio data, the first weighted data, and the second weighted data.

10. The method of claim 9, wherein
the computing of the delivery zone complexity includes
computing the delivery zone complexity by using the equation of
C=T*P(X_{c}+Xᵥ), wherein C is the delivery zone complexity, T is the second weighted data, P is the first weighted data, X_{c} is the building coverage ratio data, and Xᵥ is the floor area ratio data.

11. A method of controlling a function of a vehicle that controls a delivery-specific function of a vehicle in accordance with a delivery situation, the method comprising:
receiving, from a server, at least one of a work schedule variable, a delivery stage variable, and a delivery destination characteristic variable, each having a value that is computed based on vehicle driver's work schedule data, delivery map data, and delivery stage data and set;
classifying the delivery situation into a plurality of cases according to the value set in at least one of the work schedule variable, the delivery stage variable, and the delivery destination characteristic variable; and
controlling the delivery-specific function differently according to the plurality of cases.

12. The method of claim 11, further comprising:
for a variable that is not received from the server among the work schedule variable, the delivery stage variable, and the delivery destination characteristic variable, performing a computation based on the work schedule data, the delivery map data, and the delivery stage data to set a value.

13. The method of claim 11, wherein
the delivery-specific function contains n detailed functions, wherein n is a natural number, and
the controlling of the delivery-specific function differently according to the plurality of cases includes
setting on or off for each of the n detailed functions according to the plurality of cases.

14. The method of claim 13, wherein
the controlling of the delivery-specific function differently according to the plurality of cases includes:
setting a preset value for each of the plurality of cases to be associated with each of the cases; and
setting an on or off for each of the n detailed functions based on a bitwise value of the preset value.

15. A device for controlling a function of a vehicle that controls a delivery-specific function of a vehicle in accordance with a delivery situation, the device executing a program code loaded in one or more memory devices through one or more processors,
wherein the program code is executed to:
receive vehicle driver's work schedule data, delivery map data, and delivery stage data from a server;
allocate a work schedule variable, a delivery stage variable, and a delivery destination characteristic variable in a memory;
perform a computation based on the work schedule data, the delivery map data, and the delivery stage data to set values in the work schedule variable, the delivery stage variable, and the delivery destination characteristic variable;
classify the delivery situation into a plurality of cases based on the values set in the work schedule variable, the delivery stage variable, and the delivery destination characteristic variable; and
control the delivery-specific function differently according to the plurality of cases.

16. The device of claim 15, wherein
the delivery-specific function contains n detailed functions, wherein n is a natural number, and
the controlling of the delivery-specific function differently according to the plurality of cases includes
setting on or off for each of the n detailed functions according to the plurality of cases.

17. The device of claim 16, wherein
the controlling of the delivery-specific function differently according to the plurality of cases includes:
setting a preset value for each of the plurality of cases to be associated with each of the cases; and
setting an on or off for each of the n detailed functions based on a bitwise value of the preset value.

18. The device of claim 15, wherein
the setting of the values includes:
acquiring current time; and
setting the work schedule variable based on whether the current time corresponds to the work schedule data.

19. The device of claim 15, wherein
the delivery map data includes information about a plurality of zones set on a delivery map, and
the setting of the values includes:
acquiring a current location of the vehicle; and
setting the delivery stage variable based on which of the plurality of zones the current location corresponds to.

20. The device of claim 19, wherein
the program code is executed to,
when the current location corresponds to the delivery zone among the plurality of zones, additionally compute delivery zone complexity based on a predetermined reference for the delivery zone, and
the setting of the values includes
setting the delivery destination characteristic variable based on the delivery zone complexity.
